(19) United States
(12) Patent Application Publication
(10) Pub. No.: US 2023/0228899 A1
(43) Pub. Date: Jul. 20, 2023

(54) SYSTEM FOR DETECTING PROPERTIES OF A MATERIAL LAYER

(71) Applicant: HUESKER SYNTHETIC GMBH, Gescher (DE)

(72) Inventors: Hartmut HANGEN, Gescher (DE); Heiko PINTZ, Nordhorn (DE)

(73) Assignee: HUESKER SYNTHETIC GMBH, Gescher (DE)

(21) Appl. No.: 17/928,923

(22) PCT Filed: Mar. 2, 2021
(86) PCT No.: PCT/EP2021/055091

§ 371 Date: Nov. 30, 2022

(30) Foreign Application Priority Data
Jun. 4, 2020 (DE) 10 2020 114 874.7

(51) Int. Cl. G01V 3/12; G01V 3/08; G01B 11/06

(52) U.S. Cl. CPC G01V 3/12; G01V 3/08; G01B 11/06

(57) ABSTRACT

A system detects properties of a material layer or an embedded component of a structure or its sub-structure. The system includes a detection layer which has reflective regions reflecting electromagnetic radiation and which is designed to be embedded into a structure or its sub-structure, and a detection device which is designed to output electromagnetic radiation in the direction of the detection layer and to receive electromagnetic radiation reflected by the reflective regions of the detection layer, wherein fibers reflecting electromagnetic radiation are arranged in the reflection regions of the detection layer.

### CROSS-REFERENCE TO RELATED APPLICATIONS

This application is a national stage under 35 U.S.C. § 371 of PCT patent application PCT/EP2021/055091 filed on 2 Mar. 2021, which is pending and which is hereby incorporated by reference in its entirety for all purposes. PCT/EP2021/055091 claims priority to German Patent Application 10 2020 114 874.7 filed on 4 Jun. 2, 2020, which is hereby incorporated by reference in its entirety for all purposes.

### BACKGROUND OF THE INVENTION

### 1. Field of the Invention

The invention relates to a system for detecting properties of a material layer or of an embedded component part of a structure or its substructure. The system comprises a detection layer, which is provided with reflective regions that reflect electromagnetic radiation and is set up to be embedded in a structure or its substructure, and with a detection device, which is set up to emit electromagnetic radiation in the direction of the detection layer and to receive electromagnetic radiation reflected from the reflective regions of the detection layer.

The invention further relates to a substructure for a roadway, with a detection layer, which is disposed between two material layers of the substructure and is provided with reflective regions that reflect electromagnetic radiation.

Beyond this, the invention comprises a method for detecting properties of a material layer or of an embedded component part of a structure or its substructure. In the method, electromagnetic radiation is emitted by means of a detection device in the direction of the detection layer, which is embedded in a structure or its substructure, and the electromagnetic radiation reflected from the detection layer is received by the detection device.

### 2. Discussion of the Related Art

For new construction or rehabilitation of structures or substructures of structures, it is regularly necessary to generate material layers having a specified layer thickness or other specified properties. Furthermore, the need regularly exists to integrate component parts such as pipes or base plates, for example, in a specified position and/or with a specified alignment in a substructure.

Especially for roadway substructures, such as substructures of streets or railroad tracks, for example, the application of different material layers is necessary. The material layers are usually disposed one above the other and are used, for example, for implementation of a suitable load distribution or of a drainage function. Further material layers may be laid, for example, to increase frost resistance or to prevent a rise in dampness.

Even in embankment and landfill construction, materials having a defined layer thickness or a minimum layer thickness are regularly provided, for example in order to protect a sealing system introduced into the ground from external damage.

The layer thickness and the layer course of underground material layers as well as the position and alignment of embedded component parts is to be complied with as precisely as possible in a large number of areas of application for various reasons. A specified layer thickness is often to be adhered to as exactly as possible for cost reasons, so that the incurred material costs are optimized. Beyond that, safety aspects may be a factor for compliance with layer thicknesses. In various areas of application, a minimum layer thickness is necessary for implementation of a layer function. Knowledge of the layer thickness may also be used for the purpose of quantity determination and thus may serve as a basis for target-actual comparisons relevant to construction contracts.

The properties of such material layers or embedded component parts are to be monitored both during and after the creation of a structure or its substructure. In many areas, it is necessary to check the course of a material layer, the layer thickness and/or the position or location of an embedded component part at regular or irregular intervals. In the process, a corresponding check is usually made for the purpose of control measurements.

To avoid having to drill sample holes, builders have switched in some cases to introducing detection layers that reflect electromagnetic radiation into substructures of structures. By emitting electromagnetic radiation in the direction of the detection layer and then receiving the electromagnetic radiation reflected by the detection layer, it is possible to determine properties of material layers and embedded component parts nondestructively.

A method based on this principle for detection of boundary surfaces in ground layers is described in the publication EP 2 085 794 B1. In the described method, aluminum strips are used for reflection of the emitted electromagnetic radiation.

It has been found in practice, however, that aluminum strips embedded in a structure or its substructure are subject to a high risk of damage and are not particularly resistant to aging. The use of aluminum strips is therefore disadvantageous, especially in application situations in which the detection layer is subject to a mechanical load and in application situations in which the properties of the material layers or the properties of the component parts have to be checked over many years.

### SUMMARY OF THE INVENTION

The object underlying invention therefore consists in improving the contactless and nondestructive detection of properties of a material layer or of an embedded component part.

The object is achieved by a system of the type mentioned in the introduction, wherein fibers that reflect electromagnetic radiation are disposed in the reflective regions of the detection layer.

The invention makes use of the knowledge that radiation-reflecting fibers are substantially more robust against mechanical stress and strain and at the same time are more resistant to aging than are metal strips or metal foils. The susceptibility of the detection layer to damage is therefore considerably reduced. Furthermore, radiation-reflecting fibers from appropriately selected fiber raw material are subject to only extremely little chemical or physical aging, for example due to decay or corrosion.

The inventive system may be used, for example, to determine the position or the course of a material layer of a structure or its substructure. In this case, the material layer is preferably bounded at least on one side by the detection layer. Furthermore, the inventive system may be used to determine the position and/or the course of an embedded component part of a structure or its substructure. In this case, the embedded component part is surrounded by the detection layer at least in sections. Preferably, the detection layer in this case bears against the embedded component part. As examples, the embedded component part may be a pipe or a base plate. The component part may be embedded in the soil or in concrete, for example.

Within the meaning of the invention, radiation-reflecting fibers are such fibers that have not merely slight reflective properties for electromagnetic radiation. Preferably, the radiation-reflecting fibers are characterized by a degree of reflection for electromagnetic radiation having a frequency between 200 MHz and 2.2 GHz of at least 40%, especially of at least 60%, particularly preferably of at least 80%. Within the meaning of the invention, a radiation-reflecting fiber may be, for example, a radiation-reflecting thread or a part of a radiation-reflecting thread. Furthermore, several radiation-reflecting fibers may also form a radiation-reflecting thread. Moreover, radiation-reflecting fibers, together with fibers that are not radiation-reflecting, may form a radiation-reflecting thread. Moreover, a radiation-reflecting fiber may be, for example, a radiation-reflecting ribbon, a radiation-reflecting strip or a radiation-reflecting tape or a part of a radiation-reflecting ribbon, of a radiation-reflecting strip or of a radiation-reflecting tape.

The inventive system may further be used for elongation measurement. For this purpose, the change of distance, especially horizontal distance, between detection strips comprising radiation-reflecting fibers may be recorded and evaluated. Furthermore, the elongation of the radiation-reflecting fibers themselves may be recorded during the elongation measurement. For this purpose, a resistance measurement or electric time-domain reflectometry may be used.

The inventive system is also advantageously further developed by disposing fiber bundles having a multiplicity of fibers that reflect electromagnetic radiation in the reflective regions. Alternatively or additionally, the fibers that reflect electromagnetic radiation form several detection strips spaced apart from one another and reflecting electromagnetic radiation. Thus individual radiation-reflecting fibers preferably form a fabric, wherein the fabric may be strip-shaped. The fibers of a fiber bundle or of a detection strip preferably extend parallel to one another. For example, a fiber bundle or a detection strip comprises between 2 and 20 fibers or between 2 and 20 fiber segments disposed next to one another. The detection strips may be spaced apart from one another regularly or irregularly. Furthermore, the detection strips or the fiber bundles may be connected electrically conductively with one another. The detection strips or fiber bundles may be joined with one another by one or several electrically conductive connecting threads. The introduction or application of the one or of the several connecting threads may take place, for example, via a textile manufacturing process. The fiber bundles or detection strips may also be welded to one another. The connection between the fiber bundles or detection strips may also be made via electrically conductive plastic. The detection strips or fiber bundles may be joined with a metallic conductive element.

The detection layer of the system preferably extends in longitudinal direction, wherein the fiber bundles or detection strips extend in transverse direction, i.e. across the longitudinal direction. The detection strips may form reflective ribbons. The fibers of a fiber bundle or of a detection strip may be joined with one another at their respective ends in electrically conductive manner by means of a connecting element. The connecting element may be, for example, a terminal, for example a metal terminal. As an example, the detection strips may have a width of 10 to 100 cm, for example a width of 20 cm. The length of the detection strips corresponds preferably to the width of the detection layer. As an example, the width of the detection layer may lie in a range between 1 m and 10 m, preferably between 3 m and 8 m, for example approximately 5 m.

In a further preferred embodiment of the inventive system, the detection layer is formed as a geotextile or comprises a geotextile. The fibers that reflect electromagnetic radiation are fixed on the geotextile and/or integrated into the geotextile. The radiation-reflecting fibers or other fibers of the geotextile may be smooth or coated with size. The radiation-reflecting fibers or other fibers of the geotextile may also have single or multiple coatings The radiation-reflecting fibers and/or the geotextile are preferably stretchable. The stretchability of the radiation-reflecting fibers and/or of the geotextile is preferably implemented via elastic and/or plastic deformability. The stretchability permits an elongation measurement up to the elongation to break of the geotextile or of the fibers of the geotextile.

In a further development of the inventive system, the geotextile is formed as a woven, knitted or nonwoven fabric. The geotextile may also be a nonwoven fabric that is formed exclusively from radiation-reflecting fibers. Furthermore, the geotextile may comprise a nonwoven fabric layer that comprises exclusively radiation-reflecting fibers. As an example of the manufacture of appropriate nonwoven fabric layers, it is possible to use fiber residues from other manufacturing processes. In this case, fiber residues from other manufacturing processes may be further used, so that disposal is avoided. The radiation-reflecting fibers may be incorporated as weft fibers and/or as warp fibers into the geotextile.

In a further preferred embodiment of the inventive system, the radiation-reflecting fibers are fixed on a surface of the geotextile. For example, the radiation-reflecting fibers are vapor-deposited, glued or raschel-knitted onto the surface of the geotextile. Preferably, the radiation-reflecting fibers were applied subsequently onto the geotextile.

The inventive system is also advantageously further developed by incorporating the radiation-reflecting fibers into the geotextile by weaving, machine-knitting, raschel-knitting, sewing or embroidering. Preferably, the radiation-reflecting fibers are woven, sewed and/or embroidered into the geotextile. The radiation-reflecting fibers may be incorporated as warp fibers or weft fibers into the geotextile.

In a further preferred embodiment of the inventive method, the detection layer is formed from a fiber-composite material or comprises a fiber-composite material. The radiation-reflecting fibers are preferably fixed on the fiber-composite material and/or integrated into the fiber-composite material. The fiber-composite material may comprise not only the radiation-reflecting fibers but also further fibers, for example glass fibers or aramid fibers. The matrix of the fiber-composite material is preferably formed from one or more plastic polymers, for example from a thermosetting plastic, an elastomer and/or a thermoplastic.

In a further embodiment of the inventive system, the fibers that reflect electromagnetic radiation are formed as carbon fibers. The carbon fibers may also be called carbon fibers. The fiber bundles or detection strips respectively comprise preferably 20 to 100 grams, especially 50 to 70 grams, for example approximately 60 grams of radiation-reflecting fibers per meter. The fiber bundles or detection strips preferably have respectively a total thread thickness between 400,000 and 700,000 dtex, for example a total thread thickness of approximately 580,000 dtex.

Alternatively, the radiation-reflecting fibers may also be metal fibers. In particular, the radiation-reflecting fibers are steel fibers, possibly stainless-steel fibers. Furthermore, metal wires or thin elastic metal rods may be used as radiation-reflecting fibers.

Alternatively or in addition to the radiation-reflecting fibers, the detection layer may also comprise vapor-deposited carbon particles, via which the electromagnetic radiation emitted by the detection device may be reflected.

In a further preferred embodiment of the inventive system, the detection layer is formed as a reinforcing grid or is integrated into a reinforcing grid. The reinforcing grid preferably comprises synthetic fibers, for example of polyester, polyethylene terephthalate (PET), polypropylene (PP), polyvinyl alcohol (PVA) and/or an aramid. In particular, the detection layer is part of an asphalt reinforcement. Alternatively, the detection layer is part of a soil reinforcement.

In another preferred embodiment of the inventive system, the detection device comprises an evaluation unit, which is set up to determine the course, the thickness or an imposed elongation of a material layer or of an embedded component part of the structure or of its substructure by evaluation of the emitted and received electromagnetic radiation. For this purpose, the evaluation unit preferably determines the position, the course or an imposed elongation of the detection layer of the system. In particular, the evaluation unit is set up to perform a transit-time measurement on the basis of the emitted and received electromagnetic radiation, via which the distance between the detection device and the detection layer may be determined.

The detection device may comprise an emitter unit for emitting the electromagnetic radiation and a receiver unit for receiving the reflected electromagnetic radiation. The detection device may be set up to emit radar waves and to receive reflected radar waves. The reflective regions of the detection layer are preferably radar-reflective. Alternatively, the waves emitted and received by the detection device have a frequency between 200 MHz and 2.2 GHz.

The object underlying the invention is further achieved by a substructure of the type mentioned in the introduction, wherein fibers that reflect electromagnetic radiation are disposed in the reflective regions of the detection layer.

As an example, the substructure may be the substructure of a street or of a railroad track. The detection layer of the substructure may have one or more features described in relation to the detection layer of the system.

The detection layer may also be used in conjunction with a structure. In this case, the detection layer is disposed, for example, between two material layers of the structure or is laid on a component part of the structure. In this case also, the detection layer may be provided with radiation-reflecting regions containing radiation-reflecting fibers.

The object underlying the invention is further achieved by a method of the type mentioned in the introduction, wherein electromagnetic radiation emitted by the detection device is reflected during the inventive method by fibers that reflect electromagnetic radiation and are disposed in the reflective regions of the detection layer. The method is preferably carried out with a system according to one of the embodiments described in the foregoing. With respect to the advantages and modifications of the inventive method, reference will therefore be made first of all to the advantages and modifications of the inventive system.

The electromagnetic radiation emitted by the detection device preferably comprises radar waves. The reflective regions of the detection layer are preferably radar-reflective. The emitted electromagnetic radiation may have a linearly polarized wave component. The plane of polarization of this linearly polarized wave component may be aligned such that the main extension direction of each reflective region lies parallel to the plane in which the E wave of the linearly polarized wave component oscillates. The plane of polarization of the linearly polarized wave component may further be aligned such that the H wave of the electromagnetic radiation propagates in a plane extending in vertical direction, in which the main extension direction of the detection layer also lies.

Preferably the detection device is moving during the emission and reception of the electromagnetic radiation. Preferably the detection device is fastened on an inspection vehicle, which moves along a main extension direction of the detection layer. The inspection vehicle may be a rail-mounted vehicle. The detection device may emit electromagnetic radiation vertically downward, obliquely forward and/or obliquely backward. Furthermore, the detection device may receive electromagnetic radiation arriving vertically from below, obliquely from in front and/or obliquely from behind.

The inventive method is also advantageously further developed in that the course and/or the position of a material layer or of an embedded component part of the structure or its substructure is determined by means of evaluation of the emitted and received electromagnetic radiation by an evaluation unit of the detection device. For this purpose, preferably the course and/or the position of the detection layer is determined. Alternatively or additionally, the thickness of a material layer or of an embedded component part of the structure or its substructure is determined by means of evaluation of the emitted and received electromagnetic radiation by an evaluation unit of the detection device. Alternatively or additionally, the elongation of a material layer or of an embedded component part of the structure or its substructure is determined by means of evaluation of the emitted and received electromagnetic radiation by an evaluation unit of the detection device.

### BRIEF DESCRIPTION OF THE DRAWINGS

Preferred embodiments of the invention will be explained and described in more detail hereinafter with reference to the attached drawings, wherein:

FIG. 1 shows an exemplary embodiment of the inventive system in a perspective diagram;

FIG. 2 shows the determination of the course of a layer by means of the inventive method in a schematic diagram;

FIG. 3 shows the determination of a component-part position by means of the inventive method in a schematic diagram;

FIG. 4 shows the determination of a component-part position by means of the inventive method in a schematic diagram;

FIG. 5 shows a detection layer of an inventive system in a schematic diagram;

FIG. 6 shows a further detection layer of an inventive system in a schematic diagram;

FIG. 7 shows a further detection layer of an inventive system in a schematic diagram;

FIG. 8 shows a further detection layer of an inventive system in a schematic diagram;

FIG. 9 shows a further detection layer of an inventive system in a schematic diagram;

FIG. 10 shows a further detection layer of an inventive system in a schematic diagram; and

FIG. 11 shows a further detection layer of an inventive system in a schematic diagram.

### DETAILED DESCRIPTION OF THE PREFERRED EMBODIMENTS

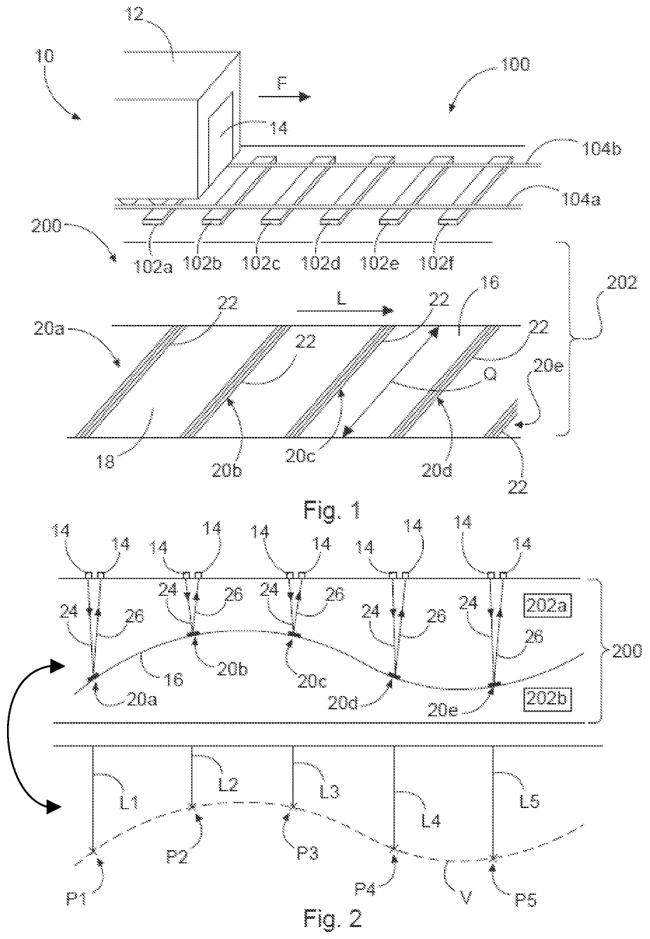

FIG. 1 shows a structure 100 constructed as a railroad track, which has crossties 102a-102f spaced apart in longitudinal direction L. Crossties 102a-102f extend in transverse direction Q, i.e. across longitudinal direction L. Two parallel rails 104a, 104b extend on crossties 102a-102f.

A substructure 200 having at least one material layer 202 is situated underneath track 100. A detection layer 16 introduced during construction of substructure 200 is situated underneath material layer 202. The layer thickness of material layer 202 can be determined nondestructively and contactlessly via detection layer 16 introduced into substructure 200.

For this purpose, a system 10 is used that comprises not only detection layer 16 but also an inspection vehicle 12. Inspection vehicle 12 is a rail-mounted vehicle, which moves along rails 104a, 104b in travel direction F. Inspection vehicle 12 may have its own drive or be moved by a third vehicle.

Detection device 14 is set up to emit electromagnetic radiation 24 in the direction of detection layer 16 and to receive electromagnetic radiation 26 reflected from detection layer 16. For radiation reflection, detection layer 16 comprises several reflective regions 20a-20e, wherein reflective regions 20a-20e comprise fibers 22 that reflect electromagnetic radiation 24. In the present case, fibers 22 are carbon fibers or carbon fibers.

Fiber bundles containing a multiplicity of radiation-reflecting fibers 22 are respectively disposed in reflective regions 20a-20e, wherein the fibers 22 form detection strips that are spaced apart from one another and that reflect electromagnetic radiation 24. Detection layer 16 comprises a geotextile 18, wherein radiation-reflecting fibers 22 are integrated into geotextile 18.

FIG. 2 shows the determination of a course V of a boundary layer between two material layers 202a, 202b. For this purpose, a detection layer 16 was introduced between the two material layers 202a, 202b during construction of substructure 200. The course V of the boundary layer between the two material layers 202a, 202b may be determined via the course of detection layer 16.

Detection layer 16 contains reflective regions 20a-20e that reflect electromagnetic radiation 24. A detection device 14 is moved above substructure 200 along the main extension direction of detection layer 16 in a manner spaced apart from detection layer 16. During this movement, detection device 14 emits electromagnetic radiation 24 comprising radar waves in the direction of detection layer 16. At least part of the emitted electromagnetic radiation 24 is reflected by reflective regions 20a-20e of detection layer 16, so that detection device 14 is able to receive the reflected electromagnetic radiation 26 once again.

On the basis of the known velocity of propagation of the emitted electromagnetic radiation 24, it is possible to perform transit-time measurements L1-L5, in order to be able to determine the distance between detection layer 16 and detection device 14 at several measurement points P1-P5. The course V of detection layer 16 and thus the course of the boundary layer between material layers 202a, 202b may be determined via measurement points P1-P5. The precision of this determination of the course may be improved via the number of points of measurement.

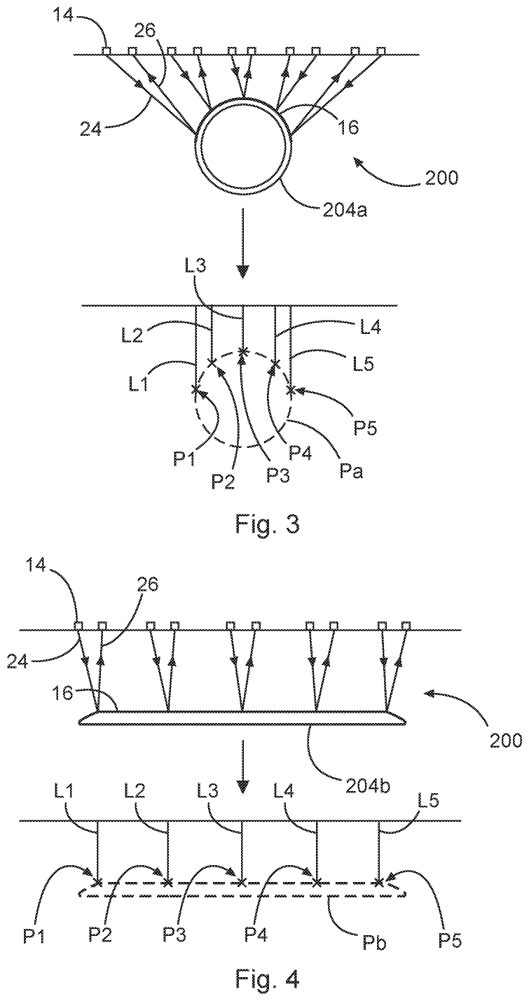

FIG. 3 schematically shows the detection of a component-part position Pa of a component part 204a. Component part 204a is a pipe segment that is part of a substructure 200. Component part 204a is embedded in a material layer. A detection layer 16, which comprises fibers 22 that reflect electromagnetic radiation 24, is situated on the upper side of component part 204a.

For position determination, a detection device 14 is moved transversely relative to the longitudinal axis of component part 204a. During this movement, detection device 14 emits electromagnetic waves 24 and receives electromagnetic radiation 26 reflected from detection layer 16.

Via several transit-time measurements L1-L5, which are made by an evaluation unit, it is possible to identify measurement points P1-P5 via a distance determination that takes into consideration the velocity of propagation of the electromagnetic radiation 24, 26. Component-part position Pa may then be determined via measurement points P1-P5.

Detection device 14 may be set up to emit electromagnetic radiation 24 obliquely forward, vertically downward and obliquely backward and to receive from these directions. As FIG. 3 shows, this is advantageous in particular in the case of curved component-part geometries.

FIG. 4 shows position detection for a component part 204b, wherein component part 204b is an embedded base plate. Component part 204b is therefore likewise part of a substructure 200.

A detection layer 16, which comprises fibers 22 that reflect electromagnetic radiation 24, is again situated on the upper side of component part 204b. Due to the emission of electromagnetic radiation 24 by means of a detection device 14 in the direction of detection layer 16 and subsequent reception of the reflected electromagnetic radiation 26, it is possible to determine the distance of component part 204b from the path of movement of detection device 14 at several measurement points P1-P5 via a transit-time evaluation. Component-part position Pb may again be determined via measurement points P1-P5.

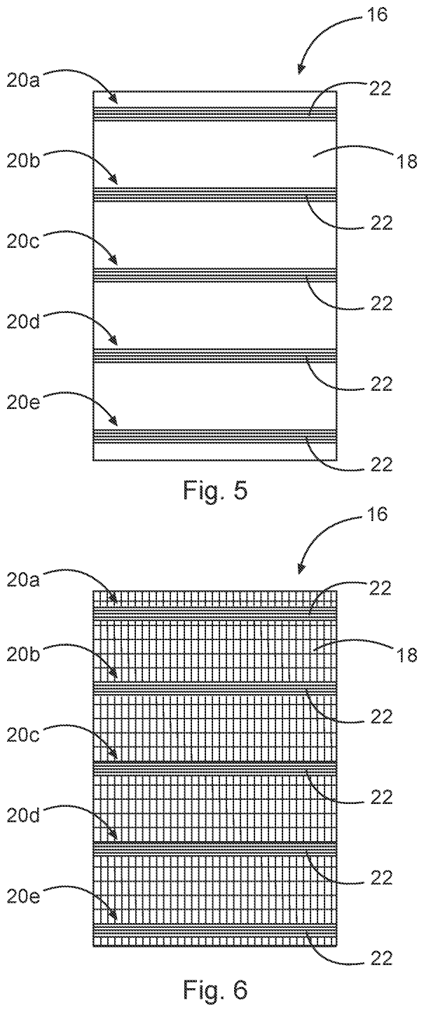

FIG. 5 shows a detection layer 16 containing several reflective regions 20a-20e. Reflective regions 20a-20e are formed by fiber bundles of carbon fibers 22.

Detection layer 16 comprises a geotextile 18 formed as a nonwoven fabric, wherein the fiber bundles of carbon fibers 22 are fixed on the geotextile 18. For example, the fibers 22 may be vapor-deposited, glued or raschel-knitted onto the surface of geotextile 18.

FIG. 6 shows a detection layer in which its geotextile 18 is formed as a woven fabric. Carbon fibers 22 are incorporated into the woven fabric. As examples, carbon fibers 22 may be woven, sewn or embroidered into geotextile 18.

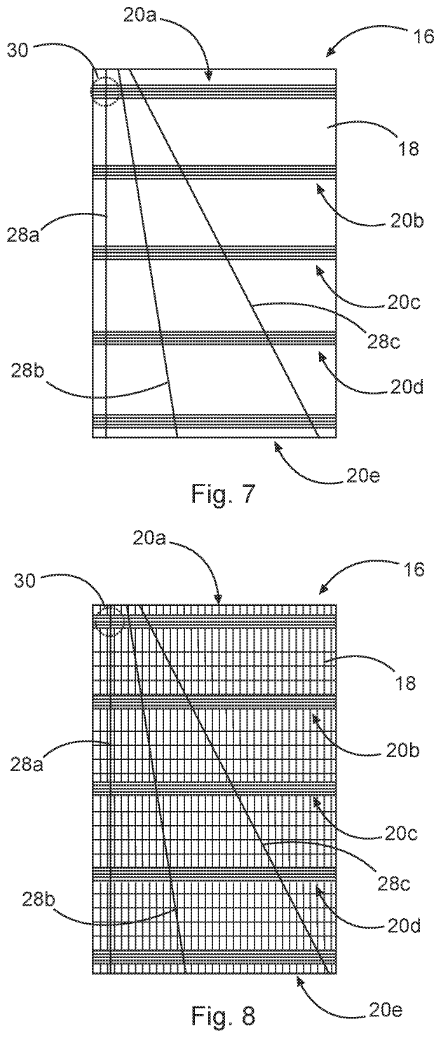

FIGS. 7 and 8 show that the detection strips of carbon fibers 22 may be joined with one another in electrically conductive manner via connecting threads 28a-28c. The reflective properties of detection layer 16 are improved via the electrically conductive connection. The diagrams show examples of a joint region 30, in which connecting threads 28a are connected electrically conductively with reflective region 20a. By means of a textile-manufacturing process, connecting threads 28a-28c may be applied on geotextile 18 or incorporated into geotextile 18.

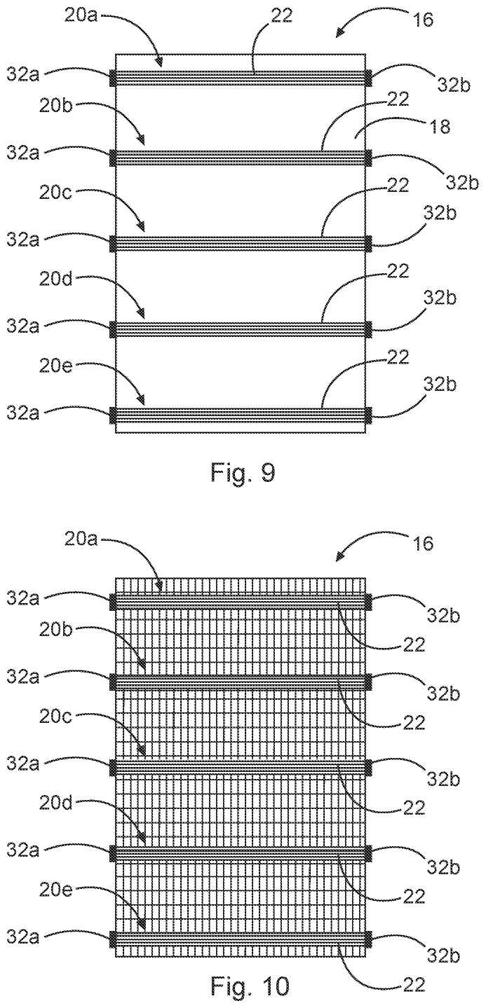

FIGS. 9 and 10 show detection layers 16, in which carbon fibers 22 of a fiber bundle are joined with one another at their respective ends in electrically conducting manner by means of a connecting element 32a, 32b. In the present case, connecting elements 32a, 32b are terminals made from an electrically conductive material. Alternatively to the illustrated terminals, other connection elements 32a, 32b may also be used, via which an electrically conductive substance-to-substance bond, frictional connection and/or interlocking connection is implemented between the carbon fibers 22 of a fiber bundle.

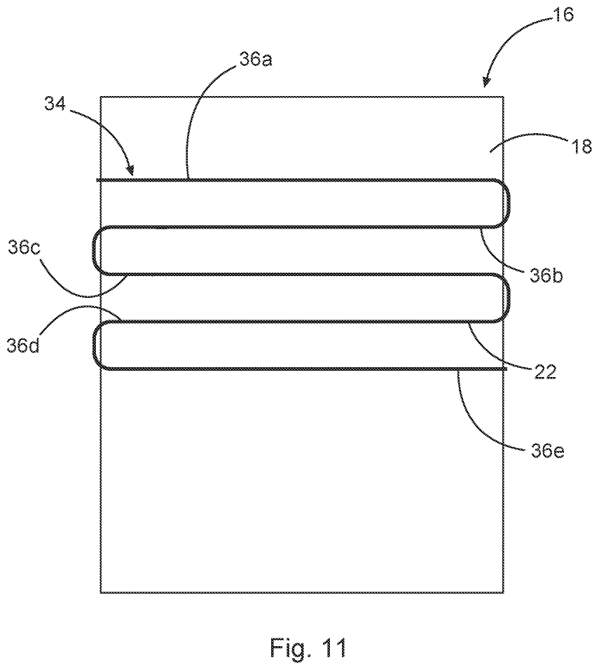

FIG. 11 shows a detection layer 16, in which a thread 34 comprising a carbon fiber 22 is incorporated as a weft thread into a geotextile 18 formed as a woven fabric. Thread 34 may either be a pure carbon thread or in addition to carbon fibers 22 may comprise still further different fibers. Thread 34 comprises several straight thread segments 36a-36e and several curved thread segments, via which the straight thread segments 36a-36e are joined to one another. Straight thread segments 36a-36e are spaced equidistantly from one another and extend parallel to one another.

Alternatively, a thread 34 comprising a carbon fiber 22 could also be incorporated as a weft thread into a geotextile 18, formed as a woven fabric, of detection layer 16.

Alternatively or in addition to the illustrated carbon threads 22, reflective regions 20a-20e of a detection layer 16 may also comprise metal threads. Detection layer 16 may be formed as a reinforcing grid or be integrated into a reinforcing grid.

### REFERENCE SYMBOLS

10 System
12 Inspection vehicle
14 Detection device
16 Detection layer
18 Geotextile
20a-20e Reflective regions
22 Fibers
24 Radiation
26 Radiation
28a-28c Connecting threads
30 Joint region
32a, 32b Connecting elements
34 Thread
36a-36e Thread segments
100 Structure
102a-102f Crossties
104a, 104b Rails
200 Substructure
202, 202a, 202b Material layers
204a, 204b Component part
F Travel direction
L Longitudinal direction
L1-L5 Transit-time measurements
Q Transverse direction
P1-P5 Measurement points
Pa, Pb Component-part positions
V Course

1. A system for detecting properties of a material layer or of an embedded component part of a structure or its substructure, the system comprising:
a detection layer, which is provided with reflective regions that reflect electromagnetic radiation and is set up to be embedded in a structure or its substructure; and
with a detection device, which is set up to emit electromagnetic radiation in the direction of the detection layer and to receive electromagnetic radiation reflected from the reflective regions of the detection layer;
wherein a plurality of fibers that reflect electromagnetic radiation are disposed in the reflective regions of the detection layer.

2. The system according to claim 1, wherein the plurality of fibers are disposed in fiber bundles, the fiber bundles reflect electromagnetic radiation and the fiber bundles are disposed in the reflective regions or the fibers that reflect electromagnetic radiation form several detection strips that are spaced apart from one another and reflect electromagnetic radiation (24).

3. The system according to claim 1,
wherein the detection layer is formed as a geotextile or comprises a geotextile, and
wherein the fibers that reflect electromagnetic radiation are fixed on the geotextile or are integrated into the geotextile.

4. The system according to claim 3,
wherein the geotextile is formed as a woven, knitted or nonwoven fabric.

5. The system according to claim 3,
characterized in that the fibers that reflect electromagnetic radiation are fixed on a surface of the geotextile.

6. The system according to claim 3, wherein the fibers that reflect electromagnetic radiation are incorporated into the geotextile by weaving, machine knitting, raschel knitting, sewing or embroidering.

7. The system according to claim 1,
wherein the detection layer is formed from a fiber composite material or comprises a fiber-composite material, and
wherein the fibers that reflect electromagnetic radiation are fixed on the fiber-composite material or are integrated into the fiber-composite material.

8. The system according to claim 1, wherein the radiation-reflecting fibers are formed as carbon fibers.

9. The system according to claim 1, wherein the detection layer is formed as a reinforcing grid or is integrated into a reinforcing grid.

10. The system according to claim 1,
wherein the detection device comprises an evaluation unit, which is set up to determine the course (V), the thickness or an imposed elongation of a material layer or of a component part of the structure or of its substructure by evaluation of the emitted and received electromagnetic radiation.

11. A substructure for a roadway, the substructure comprising:
a detection layer, which is disposed between two material layers of the substructure and is provided with reflective regions that reflect electromagnetic radiation;
wherein fibers that reflect electromagnetic radiation are disposed in the reflective regions of the detection layer.

12. A method of detecting properties of a material layer or of an embedded component part of a structure or its substructure, using a system for detecting properties of a material layer or of an embedded component part of a structure or its substructure,
the system comprising:
a detection layer, which is provided with reflective regions that reflect electromagnetic radiation and is set up to be embedded in a structure or its substructure; and
with a detection device, which is set up to emit electromagnetic radiation in the direction of the detection layer and to receive electromagnetic radiation reflected from the reflective regions of the detection layer;
wherein a plurality of fibers that reflect electromagnetic radiation are disposed in the reflective regions of the detection layer;
the method comprising the steps of:
emitting, using a detection device of the system, electromagnetic radiation in the direction of a detection layer, which is embedded in a structure or its substructure, and
receiving, using the detection device, the electromagnetic radiation reflected from the detection layer;
wherein the electromagnetic radiation emitted by the detection device is reflected by fibers that reflect electromagnetic radiation and are disposed in reflective regions of the detection layer.

13. The method according to claim 12, further comprising
determining, by an evaluation unit of the detection device, the course (V) or the position (Pa, Pb) of a material layer or of an embedded component part of the structure or its substructure by means of evaluation of the emitted and received electromagnetic radiation;
determining, by an evaluation unit of the detection device, the thickness of a material layer or of an embedded component part of the structure or its substructure by means of evaluation of the emitted and received electromagnetic radiation;
determining, by an evaluation unit of the detection device, the elongation of a material layer or of an embedded component part of the structure or its substructure by means of evaluation of the emitted and received electromagnetic radiation.
